(19) United States
(12) Patent Application Publication
(10) Pub. No.: US 2006/0197507 A1
(43) Pub. Date: Sep. 7, 2006

(54) Solar electric power supply device that can supply an electric power successively

(76) Inventor: Chao-Hsiang Wang, Chia I Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/069,504

(22) Filed: Mar. 1, 2005

(51) Int. Cl. H02J 7/00

(52) U.S. Cl. 320/166

(57) ABSTRACT

A solar electric power supply device includes a solar collector unit, an ultracapacitor assembly connected to the solar collector unit and including ultracapacitors that can be charged and discharged interchangeably, and an IC (integrated circuit) control system connected to the ultracapacitor assembly to control operation of the ultracapacitors of the ultracapacitor assembly. Thus, the solar electric power supply device can charge the storage cell successively without interruption during the charging process of the storage cell, thereby enhancing the lifetime of the storage cell.

### BACKGROUND OF THE INVENTION

1. Field of the Invention

The present invention relates to a solar electric power supply device, and more particularly to a solar electric power supply device that can supply an electric power successively.

2. Description of the Related Art

A conventional solar electric power supply device 1 in accordance with the prior art shown in FIG. 3 comprises a solar panel 11 to receive a solar energy from the sun light, a shutoff switch 12 connected to the solar panel 11, a storage cell 13 connected to the shutoff switch 12, and a load 14 connected to the storage cell 13. Thus, the solar energy received by the solar panel 11 is converted into an electric energy. Then, the shutoff switch 12 is opened to connect the solar panel 11 to the storage cell 13 so that the electric energy is supplied into the storage cell 13 so as to charge the storage cell 13. After the storage cell 13 is charged completely, the shutoff switch 12 is closed, so that the storage cell 13 can supply an electric power to the load 14. The load 14 is a road lamp, a solar heater or the like. However, the electric power from the solar panel 11 to the storage cell 13 is changed due to the weather condition, so that the electric power is supplied from the solar panel 11 to the storage cell 13 intermittently during the storage process the storage cell 13, thereby increasing the impedance of the storage cell 13, and thereby decreasing the storage capacity of the storage cell 13. In addition, the solar panel 11 needs to have a larger volume to supply a larger electric current, thereby increasing costs of fabrication.

### SUMMARY OF THE INVENTION

The primary objective of the present invention is to provide a solar electric power supply device that can supply an electric power successively.

Another objective of the present invention is to provide a solar electric power supply device, wherein the solar electric power supply device can charge the storage cell successively without interruption during the charging process of the storage cell, thereby enhancing the lifetime of the storage cell.

A further objective of the present invention is to provide a solar electric power supply device, wherein each of the ultracapacitors of the ultracapacitor assembly is charged and discharged rapidly, so that when one of the ultracapacitors of the ultracapacitor assembly is charged, another one of the ultracapacitors of the ultracapacitor assembly is discharged so as to charge the storage cell successively without incurring power interruption or delay during the charging process of the storage cell, thereby facilitating the charging action of the storage cell.

A further objective of the present invention is to provide a solar electric power supply device, wherein the ultracapacitor assembly includes multiple sets of ultracapacitors that can be charged and discharged interchangeably so as to directly supply an electric power to the load successively.

A further objective of the present invention is to provide a solar electric power supply device, wherein each of the ultracapacitors of the ultracapacitor assembly is charged and discharged rapidly, so that the volume of the solar cell of the solar collector unit can be reduced largely, thereby decreasing costs of fabrication.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a solar electric power supply device in accordance with the preferred embodiment of the present invention;

FIG. 2 is a block diagram of a solar electric power supply device in accordance with another preferred embodiment of the present invention; and

FIG. 3 is a block diagram of a conventional solar electric power supply device in accordance with the prior art.

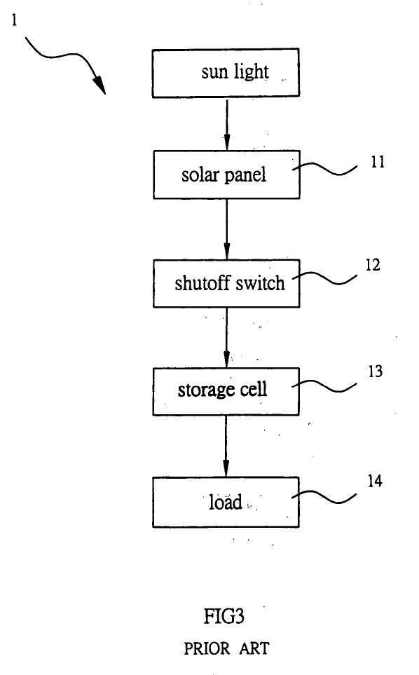

### DETAILED DESCRIPTION OF THE INVENTION

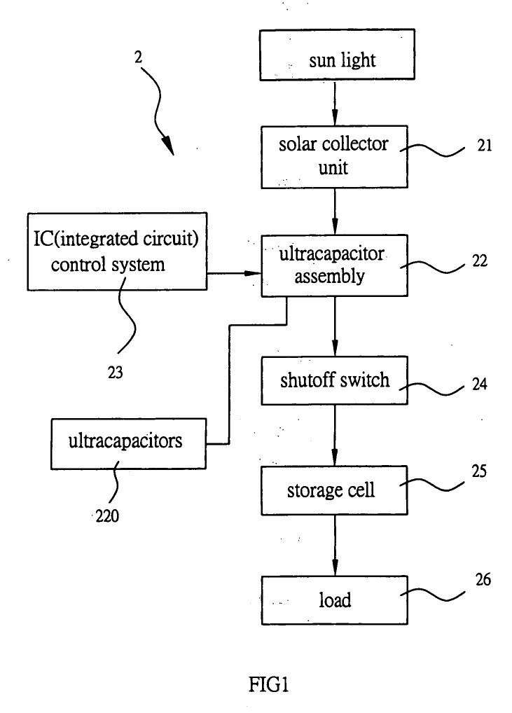

Referring to the drawings and initially to FIG. 1, a solar electric power supply device 2 in accordance with the preferred embodiment of the present invention comprises a solar collector unit 21, an ultracapacitor assembly 22, and an IC (integrated circuit) control system 23.

The solar collector unit 21 includes at least one solar cell having an electric energy converter circuit to convert the received solar energy into an electric energy.

The ultracapacitor assembly 22 is connected to the solar collector unit 21 and includes one set or multiple sets of ultracapacitors 220 that can be charged and discharged interchangeably. The ultracapacitor assembly 22 is also connected to a shutoff switch 24 which is connected to a storage cell 25 which is connected to a load 26.

The IC control system 23 is connected to the ultracapacitor assembly 22 to control operation of the ultracapacitors 220 of the ultracapacitor assembly 22.

When the IC control system 23 is used to control operation of the ultracapacitor assembly 22, a first one of the ultracapacitors of the ultracapacitor assembly 22 is controlled by the IC control system 23 to collect and accumulate the electric energy from the solar collector unit 21. After the electric energy of the first ultracapacitor of the ultracapacitor assembly 22 reaches a predetermined value, the shutoff switch 24 is opened to connect the ultracapacitor assembly 22 to the storage cell 25 so that the first ultracapacitor of the ultracapacitor assembly 22 is controlled by the IC control system 23 to supply the electric energy into the storage cell 25 so as to charge the storage cell 25. At the same, a second one of the ultracapacitors 220 of the ultracapacitor assembly 22 is controlled by the IC control system 23 to interchangeably collect and accumulate the electric energy from the solar collector unit 21 during the charging process of the storage cell 25, so that after the electric energy of the first ultracapacitor of the ultracapacitor assembly 22 is exhausted, the second ultracapacitor of the ultracapacitor assembly 22 is controlled by the IC control system 23 to supply the electric energy into the storage cell 25 so as to charge the storage cell 25 successively. Then, the first ultracapacitor of the ultracapacitor assembly 22 is controlled by the IC control system 23 to interchangeably collect and accumulate the electric energy from the solar collector unit 21 during the charging process of the storage cell 25, and the above-mentioned procedure is repeated so as to charge the storage cell 25 successively. After the storage cell 25 is charged completely, the shutoff switch 24 is closed, so that the storage cell 25 can supply an electric power to the load 26.

Thus, the ultracapacitors 220 of the ultracapacitor assembly 22 are controlled by the IC control system 23 to interchangeably collect and accumulate the electric energy from the solar collector unit 21 during the charging process of the storage cell 25, so that when one of the ultracapacitors of the ultracapacitor assembly 22 is charged, another one of the ultracapacitors of the ultracapacitor assembly 22 is discharged so as to charge the storage cell 25 successively.

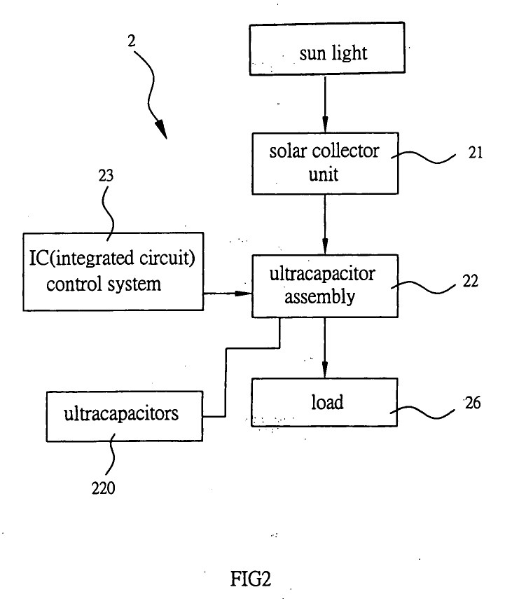

Referring to FIG. 2, the ultracapacitor assembly 22 is directly connected to the load 26.

Accordingly, the solar electric power supply device 2 can charge the storage cell 25 successively without interruption during the charging process of the storage cell 25, thereby enhancing the lifetime of the storage cell 25. In addition, each of the ultracapacitors 220 of the ultracapacitor assembly 22 is charged and discharged rapidly, so that when one of the ultracapacitors of the ultracapacitor assembly 22 is charged, another one of the ultracapacitors of the ultracapacitor assembly 22 is discharged so as to charge the storage cell 25 successively without incurring power interruption or delay during the charging process of the storage cell 25, thereby facilitating the charging action of the storage cell 25. Further, the ultracapacitor assembly 22 includes multiple sets of ultracapacitors that can be charged and discharged interchangeably so as to directly supply an electric power to the load 26 successively as shown in FIG. 2. Further, each of the ultracapacitors 220 of the ultracapacitor assembly 22 is charged and discharged rapidly, so that the volume of the solar cell of the solar collector unit 21 can be reduced largely, thereby greatly decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A solar electric power supply device, comprising:
a solar collector unit;
an ultracapacitor assembly connected to the solar collector unit and including at least two ultracapacitors that can be charged and discharged interchangeably;
an IC (integrated circuit) control system connected to the ultracapacitor assembly to control operation of the at least two ultracapacitors of the ultracapacitor assembly.

2. The solar electric power supply device in accordance with claim 1, wherein the ultracapacitor assembly includes multiple sets of ultracapacitors in pairs that can be charged and discharged interchangeably.

3. The solar electric power supply device in accordance with claim 1, wherein the solar collector unit includes at least one solar cell having an electric energy converter circuit to convert a received solar energy into an electric energy.

4. The solar electric power supply device in accordance with claim 1, wherein the ultracapacitors of the ultracapacitor assembly are controlled by the IC control system to collect and accumulate an electric energy from the solar collector unit interchangeably.

5. The solar electric power supply device in accordance with claim 4, wherein the ultracapacitor assembly is connected to a shutoff switch which is connected to a storage cell, and after the electric energy of one of the ultracapacitors of the ultracapacitor assembly reaches a predetermined value, the shutoff switch is opened to connect the ultracapacitor assembly to the storage cell so that the one ultracapacitor of the ultracapacitor assembly is controlled by the IC control system to supply the electric energy into the storage cell so as to charge the storage cell.

6. The solar electric power supply device in accordance with claim 5, wherein the ultracapacitors of the ultracapacitor assembly are controlled by the IC control system to interchangeably collect and accumulate the electric energy from the solar collector unit during the charging process of the storage cell.

7. The solar electric power supply device in accordance with claim 6, wherein when one of the ultracapacitors of the ultracapacitor assembly is charged, another one of the ultracapacitors of the ultracapacitor assembly is discharged so as to charge the storage cell successively.

8. The solar electric power supply device in accordance with claim 5, wherein the storage cell is connected to a load.

9. The solar electric power supply device in accordance with claim 4, wherein the ultracapacitor assembly is directly connected to a load, and after the electric energy of one of the ultracapacitors of the ultracapacitor assembly reaches a predetermined value, the one ultracapacitor of the ultracapacitor assembly is controlled by the IC control system to supply the electric energy into the load.

10. The solar electric power supply device in accordance with claim 1, wherein the load is a road lamp.
